(19) United States
(12) Patent Application Publication
(10) Pub. No.: US 2007/0165890 A1
(43) Pub. Date: Jul. 19, 2007

(54) Sound image localization device

(75) Inventors: Kazue Fusakawa, Kanagawa (JP); Gempo Ito, Kanagawa (JP); Atsunobu Murase, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/571,940

(22) PCT Filed: Jul. 14, 2004
(86) PCT No.: PCT/JP05/13019

§ 371 Date: Jan. 11, 2007

(30) Foreign Application Priority Data
Jul. 16, 2004 (JP) 2004-210467

(51) Int. Cl. H04R 5/02; H04R 5/00

(52) U.S. Cl. 381/309; 381/17; 381/310

(57) ABSTRACT

A sound image localization device (10) comprising: band division means (11) for dividing an inputted acoustic signal to a high-band acoustic signal and a low-band acoustic signal; a first filter (12) and a second filter (13) for localizing the high-band acoustic signal; low-band localization means (16) having a third filter (14) and a fourth filter (15) for localizing the low-band acoustic signal; a first adder (17) for adding the output signals of the first filter (12) and the third filter (14), and a second adder (18) for adding the output signals of the second filter (13) and the fourth filter (15). The sound image localization device (10) having such a configuration mitigates the limit of the listening position as compared to the conventional one and enables localization of the sound image in any direction around a listener.

### TECHNICAL FIELD OF THE INVENTION

The present invention relates to a sound image localization device for localizing a sound image constituted by sounds outputted from, for example, a loudspeaker forming part of a cellular phone, a portable game machine, and the like.

### DESCRIPTION OF THE RELATED ART

There has been provided a conventional sound image localization device, comprising a sound image localization unit for adding to an acoustic signal a transfer function for the purpose of localizing a sound image in an arbitrary direction and a filter for eliminating from sounds respectively outputted from a plurality of loudspeaker units effects caused by transfer functions of paths from the loudspeaker units to left and right ears of a listener. The conventional sound image localization device thus constructed can localize the sound image in the arbitrary direction in such a manner that a listener at a predetermined position can to listen to sounds as if the sounds are outputted from a position where the loudspeakers are in fact not provided, resulting from the fact that, in advance, at least four transfer functions respectively from one of the loudspeakers to the left and right ears of the listener have been prepared, and filter constants have been determined based on transfer functions (see, for example, Patent Document 1). Patent Document 1: Patent Laid-Open Publication No. H10-70797 (pages 3 to 5, FIG. 1)

### DISCLOSURE OF THE INVENTION

### Problems to be Solved

The conventional sound image localization device, however, encounters a drawback in that the head of a listener is required to be kept substantially stationary in order to have the listener stay at the position where the sounds are precisely reproduced in accordance with the prepared transfer functions, thereby resulting in the fact that a range of space where the listener can listen to the sound is extremely restricted.

Another drawback is encountered in the conventional sound image localization device that the loudspeaker provided in front of the listener can hardly localize the sound image into the rear of the listener, or the loudspeaker provided in the rear of the listener can hardly localize the sound image into the front of the listener, for example, in the case that the head of the listener is slightly displaced from the predetermined position where the prepared transfer functions are effective.

Particularly, the conventional sound image localization device encounters another drawback in that a sound image constituted by high-pitched sounds can be hardly localized because of the fact that a high-pitched sound is shorter in wave length than a low-pitched sound, and therefore the high-pitched sounds are subject to influences caused by displacement of the listener from the predetermined position.

The present invention is made with a view to overcoming the previously mentioned drawbacks, and it is, therefore, an object of the preset invention to provide a sound image localization device, which can localize a sound image in an arbitrary direction around the listener while mitigating the restriction of the listening position in comparison with the conventional device.

### Means of Solving the Problems

In accordance with the present invention, there is provided a sound image localization device, comprising: high-band localization means for localizing a high band sound image constituted by high band sounds equal to or higher in frequency than a predetermined value and outputted from left and right acoustic outputting units arranged so as to generate a sound field having directivity in high band sounds; and low-band localization means for localizing a low band sound image constituted by low band sounds lower in frequency than a predetermined value and outputted from the left and right acoustic outputting unit, and in which the low-band localization means is operative to localize the low band sound image, in accordance with transfer functions respectively indicative of paths from a target position, at which the low band sound image is to be localized, to left and right ears of a listener and transfer functions respectively indicative of paths from the left and right acoustic outputting units to the left and right ears of the listener.

The sound image localization device according to the present invention thus constructed as previously mentioned can prevent the high band sounds, which heavily affect localization of the sound image, from being influenced by a transfer function indicative of a path from the left loudspeaker unit to the right ear of the listener and a transfer function indicative of a path from the right loudspeaker unit to the left ear of the listener, in the sound field generated by sounds outputted from the left loudspeaker unit and the right loudspeaker unit and having a predetermined directivity in high band sounds, resulting from the fact that the high-band localization means is operative to localize a high band sound image constituted by high-band acoustic signals outputted from the left loudspeaker unit to be reached at the left ear of the listener and high-band acoustic signals outputted from the right loudspeaker unit to be reached at the right ear of the listener, and the low-band localization means is operative to localize a low band sound image constituted by low-band acoustic signals respectively outputted from the left and right loudspeaker units to be reached at the left and right ears of the listener, thereby enabling to localize the sound image in an arbitrary direction around the listener while mitigating the restriction of the listening position in comparison with the conventional device.

In the sound image localization device according to the present invention, the high-band localization means may be operative to localize the high band sound image, in accordance with a transfer function indicative of a path from a target position, at which the high band sound image is to be localized, to left and right ears of the listener, a transfer function indicative of a path from the right acoustic outputting unit to the left ear or the right ear of the listener, whichever is closer to the right acoustic outputting unit, and a transfer function indicative of a path from the left acoustic outputting unit to the left ear or the right ear of the listener, whichever is closer to the left acoustic outputting unit.

The sound image localization device according to the present invention thus constructed as previously mentioned can prevent the high band sounds, which heavily affect localization of the sound image, from being influenced by a transfer function indicative of a path from the left loudspeaker unit to the right ear of the listener and a transfer function indicative of a path from the right loudspeaker unit to the left ear of the listener, resulting from the fact that the high-band localization means is operative to localize the high band sound image in accordance with a transfer function indicative of a path from a target position, at which the high band sound image is to be localized, to left and right ears of the listener, a transfer function indicative of a path from the right acoustic outputting unit to the left ear or the right ear of the listener, whichever is closer to the right acoustic outputting unit, and a transfer function indicative of a path from the left acoustic outputting unit to the left ear or the right ear of the listener, whichever is closer to the left acoustic outputting unit, thereby enabling to localize the sound image in an arbitrary direction around the listener while mitigating the restriction of the listening position in comparison with the conventional device.

In the sound image localization device according to the present invention, the low-band localization means may include first filter means for adding an effect caused by the transfer function indicative of a path from a target position, at which the low band sound image is to be localized, to left and right ears of a listener and second filter means for eliminating an effect caused by the transfer function indicative of the path from the left and right acoustic outputting units to the left and right ears of the listener.

The sound image localization device according to the present invention thus constructed as previously mentioned can prevent the high band sounds, which heavily affect localization of the sound image, from being influenced by a transfer function indicative of a path from the left loudspeaker unit to the right ear of the listener and a transfer function indicative of a path from the right loudspeaker unit to the left ear of the listener, resulting from the fact that the low-band localization means is operative to localize the low band sound image in accordance with the transfer function indicative of the path from the target position, at which the low band sound image is to be localized, to the left and right ears of the listener and the transfer function indicative of the path from the right acoustic outputting unit to the left ear or the right ear of the listener, whichever is closer to the right acoustic outputting unit, and the transfer function indicative of the path from the left acoustic outputting unit to the left ear or the right ear of the listener, whichever is closer to the left acoustic outputting unit, thereby enabling to localize the sound image in an arbitrary direction around the listener while mitigating the restriction of the listening position in comparison with the conventional device.

Further, the sound image localization device according to the present invention may comprise directivity control means for controlling directivity in high band sounds higher in frequency than a predetermined value outputted from the left and right acoustic outputting units.

The sound image localization device according to the present invention thus constructed as previously mentioned can prevent the high band sounds, which heavily affect localization of the sound image, from being influenced by a transfer function indicative of a path from the left loudspeaker unit to the right ear of the listener and a transfer function indicative of a path from the right loudspeaker unit to the left ear of the listener, resulting from the fact that the directivity control means is operative to control directivity in high band sounds higher in frequency than a predetermined value outputted from the left and right acoustic outputting units, and thus high band sounds outputted from the left loudspeaker unit and high band sounds outputted from the right loudspeaker unit respectively generate sound fields to be reached at the left and right ears of the listener, while the high-band localization means is operative to separately localize the high band sound image constituted by high band sounds outputted from the left loudspeaker unit to be reached at the left ear of the listener and high band sounds outputted from the right loudspeaker unit to be reached at the right ear of the listener, and the low-band localization means is operative to localize the low band sound image constituted by low band sounds respectively outputted from the left and right loudspeaker units to be reached at the left and right ears of the listener, thereby enabling to localize the sound image in an arbitrary direction around the listener while mitigating the restriction of the listening position in comparison with the conventional device.

Further, in the sound image localization device according to the present invention, the directivity control means may include third filter means for eliminating an effect caused by a transfer function indicative of a path from the right acoustic outputting unit to the left ear or the right ear of the listener, whichever is far side of the right acoustic outputting unit, and a transfer function indicative of a path from the left acoustic outputting unit to the left ear or the right ear of the listener, whichever is far side of the left acoustic outputting unit.

In the sound image localization device according to the present invention thus constructed as previously mentioned, the directivity control means can control directivity in high band sounds higher in frequency than a predetermined value outputted from the left and right acoustic outputting units so as to eliminate the effect caused by the transfer function indicative of the path from the right acoustic outputting unit to the left ear or the right ear of the listener, whichever is far side of the right acoustic outputting unit, and the transfer function indicative of the path from the left acoustic outputting unit to the left ear or the right ear of the listener, whichever is far side of the left acoustic outputting unit.

In the sound image localization device according to the present invention, the left and right acoustic outputting units may be facing outwardly from each other.

The sound image localization device according to the present invention thus constructed as previously mentioned can have the left and right acoustic outputting units arranged so as to generate a sound filed having a predetermined directivity in high band sounds.

In the sound image localization device, the left and right acoustic outputting units may be respectively facing to and spaced apart from the left and right ears of the listener at a predetermined distance.

The sound image localization device according to the present invention thus constructed as previously mentioned can have the left and right acoustic outputting units arranged so as to generate a sound filed having a predetermined directivity in high band sounds.

In the sound image localization device according to the present invention, the left and right acoustic outputting units may be designed in such a manner that high band sounds outputted from the left and right acoustic outputting units and reached at the left ear of the listener and high band sounds outputted from the left and right acoustic outputting units and reached at the right ear of the listener are different from each other in a sound pressure level by equal to or greater than 10 dB.

The sound image localization device according to the present invention thus constructed as previously mentioned can have the left and right acoustic outputting units arranged so as to generate a sound filed having a predetermined directivity in high band sounds.

In the sound image localization device according to the present invention, the high-band localization means and the low-band localization means may be integral with each other.

The sound image localization device according to the present invention thus constructed as previously mentioned can eliminate the need for means for dividing into high band acoustic signals and low band acoustic signals resulting from the fact that the high-band localization means and the low-band localization means are integral with each other, thereby enabling to make the device simple in construction.

In the sound image localization device, at least one of the left and right acoustic outputting units may be constituted by a plurality of loudspeaker units.

The sound image localization device according to the present invention thus constructed as previously mentioned can localize a sound image constituted by sounds outputted from a plurality of loudspeaker units forming part of the at least one of the left and right acoustic units in an arbitrary direction around the listener.

In the sound image localization device according to the present invention, at least one of the left and right acoustic outputting units may have a predetermined directivity.

The sound image localization device according to the present invention thus constructed as previously mentioned can prevent the high band sounds, which heavily affect localization of the sound image, from being influenced by a transfer function indicative of a path from the left loudspeaker unit to the right ear of the listener and a transfer function indicative of a path from the right loudspeaker unit to the left ear of the listener, resulting from the fact that sounds outputted from a loudspeaker unit having a predetermined directivity is reached at the left or right ear of the listener, thereby enabling to localize the sound image in an arbitrary direction around the listener while mitigating the restriction of the listening position in comparison with the conventional device.

### Effect of the Invention

In accordance with the present invention, there is provided a sound image localization device which can localize a sound image in an arbitrary direction around a listener while mitigating the restriction of the listening position in comparison with the conventional device.

### BRIEF DESCRIPTION OF THE DRAWINGS

FIG. 1 A block diagram showing a first preferred embodiment of a sound image localization device according to the present invention

FIG. 2 (a) An external perspective view showing a cellular phone having applied thereto the first embodiment of the sound image localization device according to the present invention (b) A view showing an example of sound image localization carried out by the cellular phone having applied thereto the first embodiment of the sound image localization device according to the present invention

FIG. 3 A flow chart showing steps carried out by the first embodiment of the sound image localization device according to the present invention

FIG. 4 A block diagram showing a low band localization means forming part of the first embodiment of the sound image localization device according to the present invention

FIG. 5 A block diagram showing a second preferred embodiment of a sound image localization device according to the present invention

FIG. 6 A schematic diagram explaining an inaudible spot formed by a directivity control means forming part of the second embodiment of the sound image localization device according to the present invention

FIG. 7 A block diagram showing the directivity control means forming part of the second embodiment of the sound image localization device according to the present invention

FIG. 8 A flow chart showing steps carried out by the second embodiment of the sound image localization device according to the present invention

### EXPLANATION OF THE REFERENCE NUMERALS

10, 50 Sound image localization device
11 Band division means
12 First filter (high band localization means)
13 Second filter (high band localization means)
14 Third filter
15 Fourth filter
16 Low band localization means
17 First adder
18 Second adder
20 Listener
21, 51 Left loudspeaker unit (left acoustic outputting unit)
21a, 22a, 51a, 52a Axis line
22, 52 Right loudspeaker unit (right acoustic outputting unit)
23, 24, 25 Virtual loudspeaker
30 Cellular phone
31 Key board
32 Liquid crystal screen
41 Fifth filter (first filter means)
42 Sixth filter (first filter means)
43 First inverse filter (second filter means)
44 Second inverse filter (second filter means)
45 Third inverse filter (second filter means)
46 Fourth inverse filter (second filter means)
60 Directivity control means
61 First compensation filter (third filter means)
62 Second compensation filter (third filter means)
63 First directivity control filter (third filter means)
64 Second directivity control filter (third filter means)
65 Third adder
66 Fourth adder

### DESCRIPTION OF THE PREFERRED EMBODIMENTS

Preferred embodiments of the present invention will be described hereinafter with reference to the drawings.

### First Preferred Embodiment

Now, the construction of a first preferred embodiment of a sound image localization device according to the present invention will be described hereinlater.

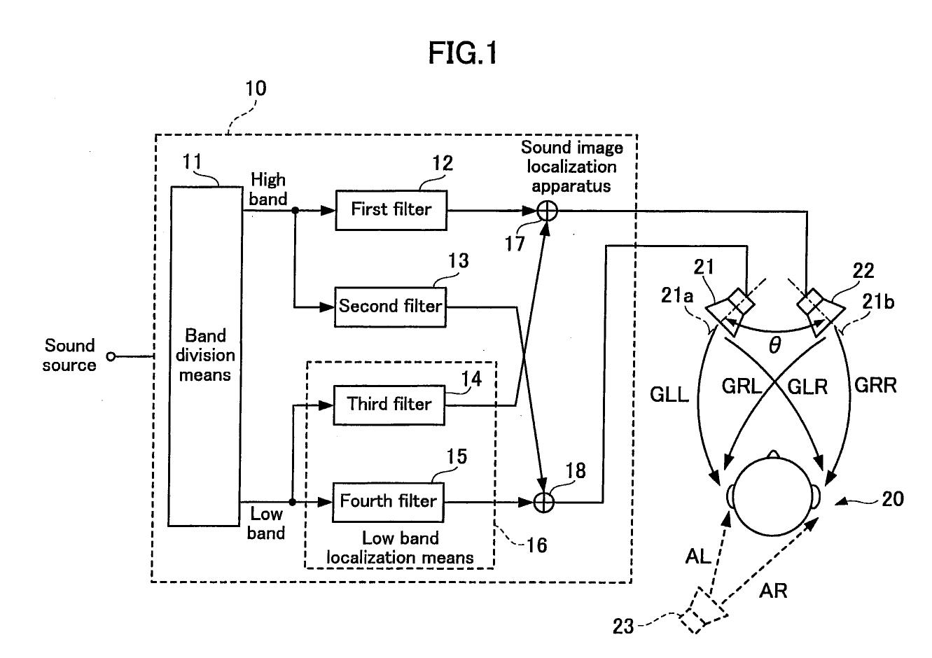

The present embodiment of the sound image localization device 10 is shown in FIG. 1 as comprising band division means 11 for dividing an inputted acoustic signal to a high-band acoustic signal and a low-band acoustic signal, a first filter 12 and a second filter 13 for localizing the high-band acoustic signal, low-band localization means 16 having a third filter 14 and a fourth filter 15 for localizing the low-band acoustic signal, a first adder 17 for adding output signals of the first filter 12 and the third filter 14, and a second adder 18 for adding output signals of the second filter 13 and the fourth filter 15.

The sound image localization device 10 is constituted by, for example, a microcomputer, or a DSP (Digital Signal Processor), and connected with a left acoustic outputting unit constituted by a left loudspeaker unit 21 and a right acoustic outputting unit constituted by a right loudspeaker unit 22, respectively disposed in front of a listener 20.

The left loudspeaker unit 21 and the right loudspeaker unit 22 are arranged at a close distance from each other to have axis lines 21a and 22a respectively indicative of directions of sounds outputted from the left and right loudspeaker units 21 and 22 define a predetermined angle θ with respect to each other. Here, the distance and the angle θ between the left and right loudspeaker units 21 and 22 are set in such a manner that high band sounds outputted from the left and right loudspeaker units 21 and 22 and reached at the left ear of the listener 20 and high band sounds outputted from the left and right loudspeaker units 21 and 22 and reached at the right ear of the listener 20 are different from each other in a sound pressure level by equal to or greater than, for example, 10 dB. This arrangement makes the left loudspeaker unit 21 and the right loudspeaker unit 22 have a directivity in high band sounds.

The band division means 11 is designed to divide an inputted acoustic signal, with 2 kHz as a reference frequency, to a high-band acoustic signal equal to or higher in frequency than 2 kHz and a low-band acoustic signal lower in frequency than 2 kHz.

The first filter 12 and the second filter 13 are constituted by, for example, FIR (Finite Impulse Response) filters including a delay unit, a multiplier, an adder, and the like, and designed to compensate the high-band acoustic signal, in accordance with a transfer function GLL indicative of a path from the left loudspeaker unit 21 to the left ear of the listener 20 and a transfer function GRR indicative of a path from the right loudspeaker unit 22 to the right ear of the listener 20 to have high band components of the high-band acoustic signal processed in accordance with a head-related transfer function in an arbitrary direction around the listener 20.

In the present embodiment, for the purpose of simplifying the description and assisting in understanding, “the arbitrary direction around the listener 20” is assumed to be a left rear direction of the listener 20 as shown in, for example, FIG. 1, and hereinlater simply referred to as a “target position”. The present embodiment of the sound image localization device 10 is operative to localize a sound image at this target position to have the listener 20 recognize sounds as if outputted from a virtual loudspeaker 23. The head-related transfer function is intended to mean a transfer function indicative of a sound path from the virtual loudspeaker 23 to an entrance of an external auditory canal of the listener 20. The head-related transfer function from the virtual loudspeaker 23 to the left ear of the listener will be hereinlater referred to as a “head-related transfer function AL”, and the head-related transfer function from the virtual loudspeaker 23 to the right ear of the listener will be hereinlater referred to as a “head-related transfer function AR”.

The third filter 14 and the fourth filter 15 are constituted by, for example, FIR filters, and designed to compensate the low-band acoustic signal, in accordance with the transfer function GLL indicative of the path from the left loudspeaker unit 21 to the left ear of the listener 20, a transfer function GLR indicative of the path from the left loudspeaker unit 21 to the right ear of the listener 20, the transfer function GRR indicative of the path from the right loudspeaker unit 22 to the right ear of the listener 20, and a transfer function GRL indicative of the path from the right loudspeaker unit 22 to the left ear of the listener 20 to have low band components of the low-band acoustic signal processed in accordance with a head-related transfer function in an arbitrary direction around the listener 20.

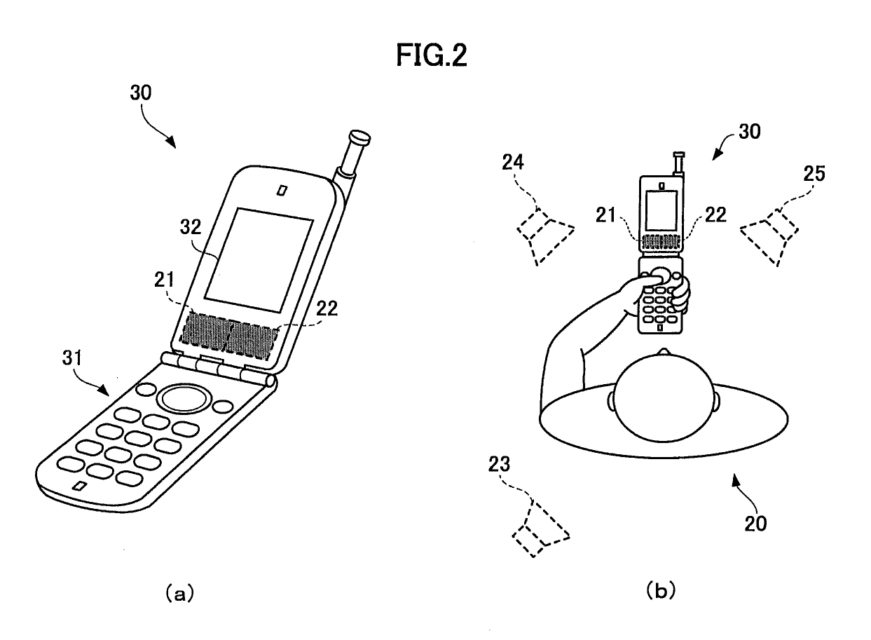

The sound image localization device 10 is applicable to, for example, a cellular phone as shown in FIG. 2(a). The cellular phone 30 shown in FIG. 2(a) comprises a key board 31, a liquid crystal screen 32, a left loudspeaker unit 21 and a right loudspeaker unit 33, both of which are disposed below the liquid crystal screen 32, mounted within a housing of the cellular phone 30, and arranged at a close distance from each other to have the angle θ defined by directions of sounds respectively outputted from the left and right loudspeaker units 21 and 22 with respect to each other in the case of the listener 20, as described in the above.

Further, the left and right loudspeaker units 21 and 22 are arranged at a distance from the listener 20 in such a manner that sounds outputted from the left and right loudspeaker units 21 and 22 and reached at the left ear of the listener 20 and sounds outputted from the left and right loudspeaker units 21 and 22 and reached at the right ear of the listener 20 are different from each other in a sound pressure level by a predetermined value when the listener 20 has the cellular phone 30 in hand, as shown in FIG. 2(b). The sounds outputted from the left and right loudspeaker units 21 and 22 and reached at the left ear of the listener 20 and the sounds outputted from the left and right loudspeaker units 21 and 22 and reached at the right ear of the listener 20 may be different from each other in a sound pressure level by equal to or greater than, for example, 10 dB.

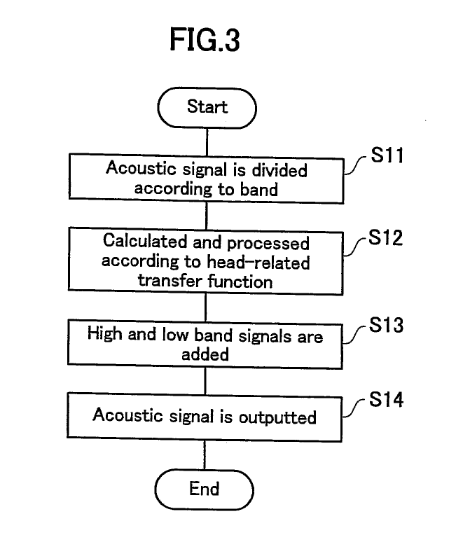

Then, the operation of the present embodiment of the sound image localization device 10 will be described hereinlater with reference to FIGS. 1 and 3.

The band division means 11 is operated to divide an inputted acoustic signal into a high-band acoustic signal and a low-band acoustic signal (step S11). In the case that as a reference frequency for division is used, for example, 2 kHz, the inputted acoustic signals are divided into the high-band acoustic signals equal to or higher in frequency than 2 kHz and the low-band acoustic signals lower in frequency than 2 kHz.

Then, the first filter 12, the second filter 13, the third filter 14, and the fourth filter 15 are operated to have the high-band acoustic signal and the low-band acoustic signal processed in accordance with the head-related transfer functions AL and AR (step S12). In the concrete, the high-band acoustic signal and the low-band acoustic signal are processed in accordance with predetermined filter coefficients as described hereinlater.

Description hereinlater will be directed to determining filter coefficients to be used for the high-band acoustic signals. The first filter 12 and the second filter 13 are respectively set at filter coefficients HR and HL, represented by the expressions (1) and (2) described as below.
HR=AR/GRR (Expression 1)
HL=AL/GLL (Expression 2)

The first filter 12 and the second filter 13, respectively set at the filter coefficients HR and HL, are respectively and separately adapted to compensate the transfer function GLL indicative of the path from the left loudspeaker unit 21 to the left ear of the listener 20 and the transfer function GRR indicative of the path from the right loudspeaker unit 22 to the right ear of the listener 20, as shown in FIG. 1 to have the high band components processed in accordance with the head-related transfer function AL and the head-related transfer function AR in target directions. The high band sounds heavily affect localization of the sound image. The first filter 12 and the second filter 13 thus constructed can prevent the high band sounds from being influenced by transfer coefficients indicative of a path from the left loudspeaker unit to the right ear of the listener and a path from the right loudspeaker unit to the left ear of the listener, resulting from the fact that the first filter 12 and the second filter 13 are operative to localize a high band sound image constituted by high band sounds in accordance with the head-related transfer functions AL and AR respectively indicative of paths from the virtual loudspeaker 23, viz., a target position at which the high band sound image is to be localized, to the left and right ears of the listener 20, the transfer function GLL indicative of a path from the left loudspeaker unit 21 to the left ear of the right ear of the listener 20, whichever is closer to the left loudspeaker unit 21, viz., the left ear of the listener 20, and the transfer function GRR indicative of a path from the right loudspeaker unit 22 to the left ear of the right ear of the listener 20, whichever is closer to the right loudspeaker unit 22, viz., the right ear of the listener 20. This leads to the fact that the first filter 12 and the second filter 13 thus constructed can localize a sound image in an arbitrary direction around a listener while mitigating the restriction of the listening position in comparison with the conventional device.

Description hereinlater will be directed to determining filter coefficients to be used for the low-band acoustic signals. The third filter 14 and the fourth filter 15 are respectively set at filter coefficients FR and FL, represented by the expressions (3) described as below.

$$[ \begin{matrix}FL \\ FR\end{matrix} ] = {[ \begin{matrix}GLL & GRL \\ GLR & GRR\end{matrix} ]}^{- 1} [ \begin{matrix}AL \\ AR\end{matrix} ] \qquad ( Expression 3 )$$

The third filter 14 and the fourth filter 15, respectively set at the filter coefficients FR and FL, are operative to compensate the transfer function GLL indicative of the path from the left loudspeaker unit 21 to the left ear of the listener 20, the transfer function GLR indicative of the path from the left loudspeaker unit 21 to the right ear of the listener 20, the transfer function GRR indicative of the path from the right loudspeaker unit 22 to the right ear of the listener 20, and the transfer function GRL indicative of the path from the right loudspeaker unit 22 to the left ear of the listener 20 to have the low-band components processed in accordance with head-related transfer functions in the target directions.

The low-band acoustic signal is longer in a wave length than the high-band acoustic signal. This means that sounds, for example, outputted from the left loudspeaker unit are diffracted and inputted to the right ear of the listener 20, and thus a crosstalk occurs even in the case that the left loudspeaker unit 21 and the right loudspeaker unit 22 are arranged at a close distance from and angled with respect to each other at an angle θ to have predetermined directivities, as shown in FIG. 1. Therefore, the third filter 14 and the fourth filter 15 are respectively set at the filter coefficients FR and FL, which have been in advance calculated and determined based on inverse filtering processes of the four transfer functions GLL, GLR, GRR, and GRL, and computation of the head-related transfer functions AL and AR in the target direction, as clearly seen from Expression 3.

Subsequently, the acoustic signals outputted from the first filter 12 and the second filter 13 are added by the first adder 17, and the acoustic signals outputted from the third filter 14 and the fourth filter 15 are added by the second adder 18 (step S13).

Then, the acoustic signals respectively added by the first adder 17 and the second adder 18 are outputted to the right loudspeaker 22 and the left loudspeaker 21 (step S14).

The cellular phone 30, which has the sound image localization device 10 and operative to carry out the above operations, can make the listener 20 recognize sounds as if outputted from the virtual loudspeaker 23 when the listener 20 has the cellular phone 30 in hand, as shown in FIG. 2(b). Further, the cellular phone 30 can make the listener 20 recognize sounds as if outputted from the other virtual loudspeaker 24 or 25 by changing the head-related transfer functions AL and AR.

From the foregoing description, it will be understood that the present embodiment of the sound image localization device 10 can prevent the high band sounds, which heavily affect localization of the sound image, from being influenced by the transfer coefficients GLR indicative of the path from the left loudspeaker unit 21 to the right ear of the listener and the transfer coefficients GRL indicative of the path from the right loudspeaker unit 22 to the left ear of the listener, in a sound field, which has a predetermined directivity in high band sounds, generated by sounds outputted from the left loudspeaker unit 21 and the right loudspeaker unit 22, resulting from the fact that the first filter 12 and the second filter 13 are respectively and separately operative to localize a high band sound image constituted by left and right high-band acoustic signals, which are relatively higher in a sound pressure level than the other acoustic signals to be reached at the left and right ears of the listener 20, and the third filter 14 and the fourth filter 15 are operative to carry out inverse filtering processes on the sound field. This leads to the fact that the present embodiment of the sound image localization device 10 can localize a sound image in an arbitrary direction around a listener 20 while mitigating the restriction of the listening position in comparison with the conventional device.

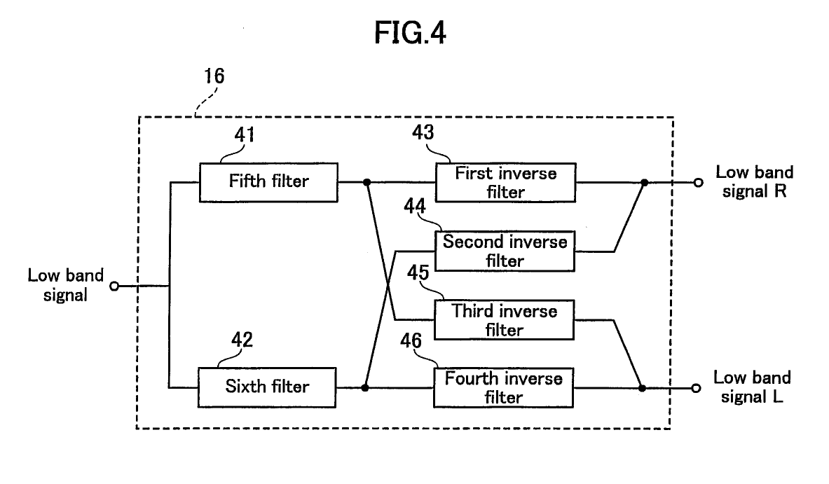

Further, while there has been described in the present embodiment about the fact that the low-band localization means 16 is constituted by the third filter 14 and the fourth filter 15, this does not limit the present invention. According to the present invention, the same effect can still be obtained when the low-band localization means 16 is constructed in such a manner as shown in FIG. 4.

The low-band localization means 16 shown in FIG. 4 includes a fifth filter 41 and a sixth filter 42 respectively operative to have the low band signals processed in accordance with the head-related transfer function AL and the head-related transfer function AR in the target directions, in place of the third filter 14 and the fourth filter 15. The low-band localization means 16 shown in FIG. 4 further includes a first inverse filter 43, a second inverse filter 44, a third inverse filter 45, and a fourth inverse filter 46 for, respectively, having the acoustic signals processed in accordance with inverse filtering the four transfer functions GLL, GLR, GRR, and GRL, to eliminate effects caused by the transfer functions GLL, GLR, GRR, and GRL from the reproduced sound field. The fifth filter 41, the sixth filter 42, the first inverse filter 43, the second inverse filter 44, the third inverse filter 45, and the fourth inverse filter 46 may be constituted by, for example, a FIR filter.

The fifth filter 41 and the sixth filter 42 collectively constitute first filter means for adding effects caused by the transfer functions AR and AL respectively indicative of the paths from the virtual loudspeaker 23, viz., the target position at which the low band sound image is to be localized, to the left and right ears of the listener, and the first inverse filter 43, the second inverse filter 44, the third inverse filter 45, and the fourth inverse filter 46 collectively constitute second filter means for eliminating from the sound image constituted by low band sounds effects caused by the transfer functions GLL, GLR, GRR, and GRL indicative of paths from the left loudspeaker unit 21 and the right loudspeaker unit 22 to the left and right ears of the listener.

The fifth filter 41 and the sixth filter 42 are respectively set at the filter coefficients AR and AL, and the first inverse filter 43, the second inverse filter 44, the third inverse filter 45, and the fourth inverse filter 46 are respectively set at filter coefficients FLL, FLR, FRL, and FRR represented by the expression (4) described as below.

$$[ \begin{matrix}FLL & FRL \\ FLR & FRR\end{matrix} ] = {[ \begin{matrix}GLL & GRL \\ GLR & GRR\end{matrix} ]}^{- 1} \qquad ( Expression 4 )$$

While there has been described in the present embodiment about the fact that the band division means 11 is disposed prior to the first filter 12, the second filter 13, the third filter 14 and the fourth filter 15, this does not limit the present invention. According to the present invention, the same effect can still be obtained when the band division means 11 is disposed posterior to the first filter 12, the second filter 13, the third filter 14 and the fourth filter 15.

Further, while there has been described in the present embodiment about the fact that the band division means 11, the first adder 17, and second adder 18 are comprised in the sound image localization device 10, this does not limit the present invention.

According to the present invention, the same effect can still be obtained when the sound image localization device 10 comprises a right channel filter having the first filter 12 and the third filter 14 integrally included therein, a left channel filter having the second filter 13 and the fourth filter 15 integrally included therein, and each of the right channel filter and the left channel filter is operative to localize sound images constituted by high band sounds and low band sounds even though the band division means 11, the first adder 17, and the second adder 18 are omitted, and thus the construction is simplified.

Further, in the case of an device such as, for example, a cellular phone and a portable game machine, which the reproduction of low band sounds is regarded not so much as important as the reproduction of high band sounds, the same effect can still be obtained even though the band division means 11 and low-band localization means 16 are omitted, and thus the construction of the sound image localization device 10 is simplified.

While it has been described in the present embodiment about the fact a that sound image is localized based on sounds outputted from two sound sources, viz., the left loudspeaker unit 21 and the right loudspeaker unit 22, this does not limit the present invention. The same effect can still be obtained when, for example, the left loudspeaker unit is constituted by two loudspeaker units, and the right loudspeaker unit is constituted by one loudspeaker unit. In this case, right and left sound images can be separately localized when, for example, as one of the left loudspeaker units may be used a directional loudspeaker unit having a sharp directivity, so that the sounds outputted from the directional loudspeaker unit and reached at the left ear of the listener is different in a sound pressure level from the those reached at the right ear of the listener by equal to or greater than 10 dB.

Further, while it has been described in the present embodiment that the left loudspeaker unit 21 and the right loudspeaker unit 22 are disposed facing outwardly from each other, this does not limit the present invention. The same effect can still be obtained when, for example, the left loudspeaker unit 21 and the right loudspeaker unit 22 are facing to and spaced apart at a predetermined distance from the left and right ears of the listener. Similarly, in such a case that the left and right loudspeaker units are ensured to have sufficient directivities, the band division means 11 may be omitted and the fourth filter 15 and the third filter 14 may respectively carry out sound image localization processes the same as those carried out by the first filter 12 and the second filter 13 to have the fourth filter 15 and the third filter 14 respectively and separately carry out left and right sound image localization processes on the acoustic signals in whole range.

### Second Preferred Embodiment

Now, the construction of a second preferred embodiment of a sound image localization device according to the present invention will be described hereinlater.

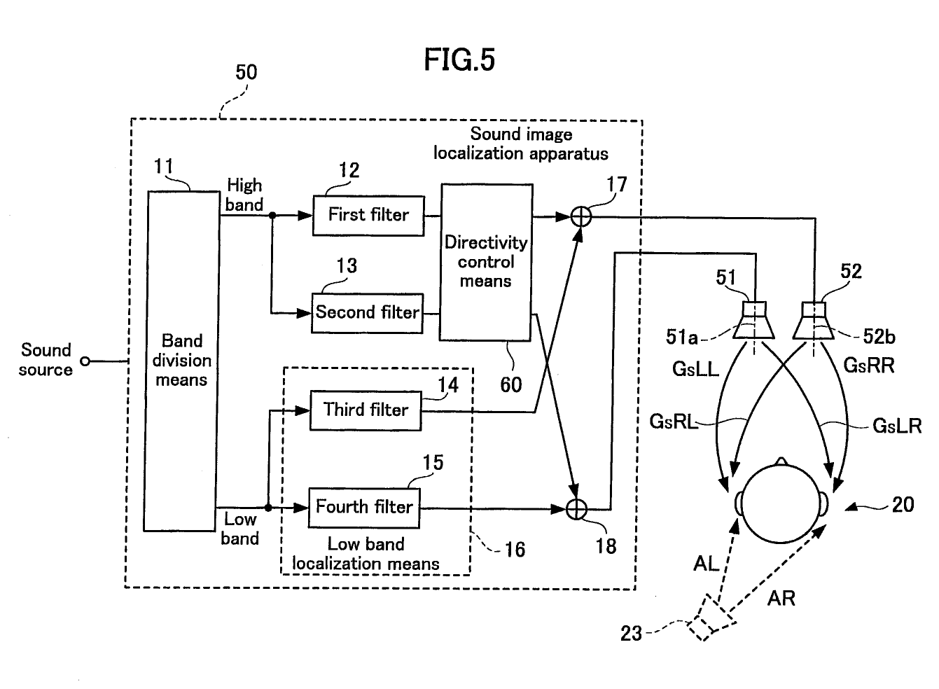

As clearly seen from FIG. 5, the present embodiment of the sound image localization device 50 is the same in construction as those of the first embodiment of the sound image localization device 10 further comprising directivity control means 60 disposed posterior to the first filter 12 and the second filter 13. The parts or elements of the second embodiment the same as those of the first embodiment of the sound image localization device 10 have respective reference numerals the same as those of the first embodiment and will thus not be described hereinafter.

Further, the present embodiment of the sound image localization device 50 is connected with a left loudspeaker unit 51 and a right loudspeaker unit 52 respectively arranged in front of a listener 20 at a close distance from each other to have axis lines 51a and 52a respectively indicative of directions of sounds outputted from the left and right loudspeaker units 51 and 52 extend in parallel relationship with each other. Here, it is assumed that a transfer function indicative of a path from the left loudspeaker unit 51 to a left ear of the listener is hereinlater referred to GsLL, a transfer function indicative of a path from the left loudspeaker unit 51 to a right ear of the listener is hereinlater referred to GsLR, a transfer function indicative of a path from the right loudspeaker unit 52 to the right ear of the listener is hereinlater referred to GsRR, and a transfer function indicative of a path from the right loudspeaker unit 52 to the left ear of the listener is hereinlater referred to GsRL.

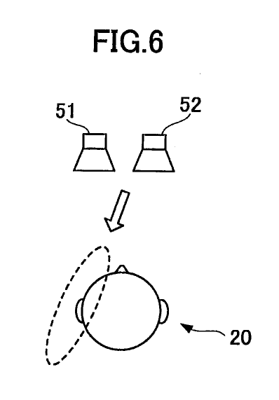

The directivity control means 60 is constituted by, for example, a microcomputer, or a DSP (Digital Signal Processor), and designed to control the directivities of left loudspeaker unit 51 and the right loudspeaker unit 52 to cancel a crosstalk occurred from the left loudspeaker unit 51 and the right loudspeaker unit 52 to the left and right ears of the listener 20, i.e., high band acoustic signals transferred in accordance with the transfer functions GsLR and GsRL, hereinlater simply referred to as “crosstalk signals”. In the present embodiment, for the purpose of simplifying the description and assisting in understanding, it is assumed that sounds outputted from the right loudspeaker unit 52 form an inaudible spot (illustrated as a dotted line) in the direction to the entrance of the left ear of the listener 20 as shown in FIG. 6. In the present embodiment, the filter coefficients HR, HL, FL, and FR to be set to the first filter 12, the second filter 13, the third filter 14, and the fourth filter 15, and in the case that inverse filter functions are applied, the filter coefficients FLL, FLR, FRL, and FRR to be set to the first inverse filter 43, the second inverse filter 44, the third inverse filter 45, and the fourth inverse filter 46, can be calculated in accordance with the expressions (1) through (4) by assigning GsRR to GRR, GsLL to GLL, GsRR to GRL, and GsLR to GLR.

In the concrete, the directivity control means 60 is constituted by, a first compensation filter 61, a second compensation filter 62, a first directivity control filter 63, and a second directivity control filter 64, a third adder 65, and a fourth adder 66.

The first directivity control filter 63 is adapted to output to a left channel a crosstalk cancel signal for canceling a crosstalk signal outputted from the right loudspeaker unit 52 to be inputted to the left ear of the listener 20, by way of a delay process and a phase inversion process. Here, the delay process is intended to mean a process to make a time taken for high band sounds outputted from the left loudspeaker unit 51 to arrive at the right ear of the listener 20 coincide with a time taken for high band sounds outputted from the right loudspeaker unit 52 to arrive at the right ear of the listener 20.

The second directivity control filter 64 is adapted to output to a right channel a crosstalk cancel signal for canceling a crosstalk signal outputted from the left loudspeaker unit 51 to be inputted to the right ear of the listener 20, by way of a delay process and a phase inversion process. Here, the delay process is intended to mean a process to make a time taken for high band sounds outputted from the right loudspeaker unit 52 to arrive at the left ear of the listener 20 coincide with a time taken for high band sounds outputted from the left loudspeaker unit 51 to arrive at the left ear of the listener 20.

The first compensation filter 61 is adapted to compensate a target signal for distortion caused by the crosstalk cancel signal outputted from the left loudspeaker unit 51 and arrived at the right ear of the listener 20.

The second compensation filter 62 is adapted to compensate a target signal for distortion caused by the crosstalk cancel signal outputted from the right loudspeaker unit 52 and arrived at the left ear of the listener 20.

The third adder 65 is operative to add up an output signal from the first compensation filter 61 and an output signal from the second directivity control filter 64 to be outputted to the first adder 17. The fourth adder 66 is operative to add up an output signal from the second compensation filter 62 and an output signal from the first directivity control filter 63 to be outputted to the second adder 18.

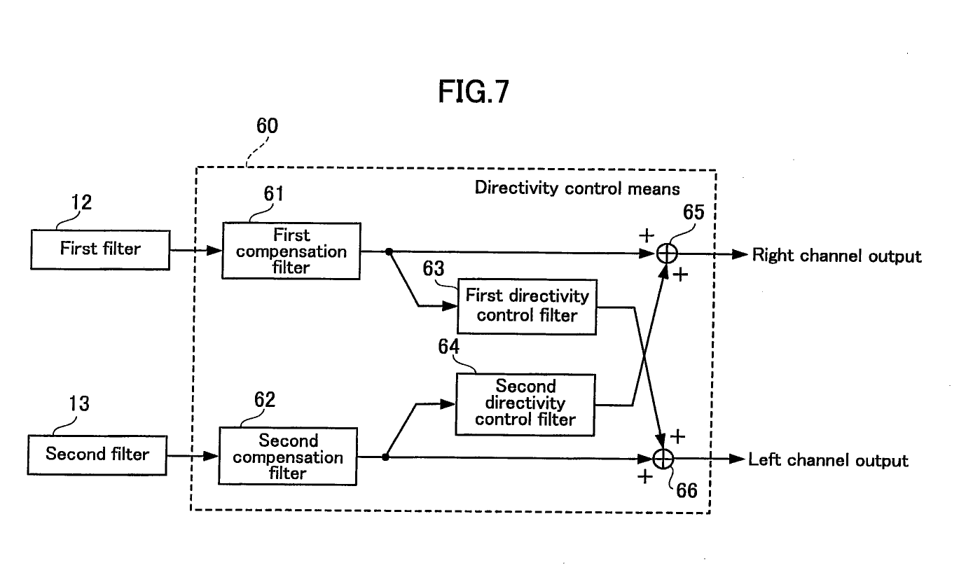

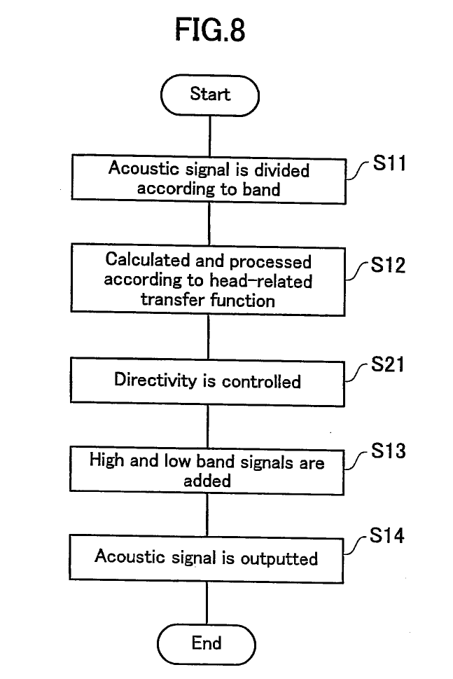

Then, the operation of the present embodiment of the sound image localization device 50 will be described hereinlater with reference to FIGS. 7 and 8. The description of the operation of the present embodiment the same as that of the first embodiment of the sound image localization device 10 is omitted, and thus only the operation of the directivity control means 60 will be described hereinlater.

In the step S12 shown in FIG. 8, high band acoustic signals calculated and processed by the first filter 12 and the second filter 13 are respectively inputted to the first compensation filter 61 and the second compensation filter 62 forming part of the directivity control means 60, and the first compensation filter 61 and the second compensation filter 62 are operated to carry out directivity control processes on the high band acoustic signals (step S21).

In the concrete, the first compensation filter 61 and the second compensation filter 62 are set at filter coefficients CR and CL, represented by the expressions (5) and (6) described as below.
CR=(GsRR+DR×GsLR)⁻¹×GsRR (Expressions 5)
CL=(GsLL+DL×GsRL)⁻¹×GsLL (Expressions 6)

Here, DR and DL are intended to mean filter constants respectively set to the first directivity control filter 63 and the second directivity control filter 64, and calculated so as to have crosstalk cancel signals outputted to inputted high band acoustic signals, by way of phase inversion and delay processes.

The high band acoustic signal compensated by the first compensation filter 61 is outputted to the third adder 65 and the first directivity control filter 63. Likewise, the high band acoustic signal compensated by the second compensation filter 62 is outputted to the fourth adder 66 and the second directivity control filter 64.

Then, the third adder 65 is operated to add up the high band acoustic signal outputted from the first compensation filter 61 and the high band acoustic signal outputted from the second directivity control filter 64 to be outputted to the first adder 17. Likewise, the fourth adder 66 is operated to add up the high band acoustic signal outputted from the second compensation filter 62 and the high band acoustic signal outputted from the first directivity control filter 63 to be outputted to the first adder 18. As will be seen from the foregoing description, the first compensation filter 61, the first directivity control filter 63, the second compensation filter 62, and the second directivity control filter 64 collectively constitute third filter means for eliminating effects caused by the transfer function GsLR indicative of a path from the left loudspeaker unit to the left ear or the right ear of the listener, whichever is far side of the left acoustic outputting unit, i.e., the right ear of the listener, and the transfer function GsRL indicative of a path from the right loudspeaker unit to the left ear or the right ear of the listener, whichever is far side of the right acoustic outputting unit, i.e., the left ear of the listener.

From the foregoing description, it is to be understood that the present embodiment of the sound image localization device 50 can prevent the high band sounds, which heavily affect the localization of the sound image, from being influenced by the transfer function GsLR indicative of the path from the left loudspeaker unit 51 to the right ear of the listener, and the transfer function GsRL indicative of the path from the right loudspeaker unit 52 to the left ear of the listener. This leads to the fact that the present embodiment of the sound image localization device 50 can localize a sound image in an arbitrary direction around a listener 20 while mitigating the restriction of the listening position in comparison with the conventional apparatus.

While there has been described in the present embodiment about the fact that the left loudspeaker unit 51 and the right loudspeaker unit 52 are arranged at a close distance from and in parallel relationship with each other, this does not limit the present invention. The same effect can still be obtained when the directivity control processes are carried out as described in the above even though the left and right loudspeaker units may be disposed facing outwardly from each other similar to the left loudspeaker unit 21 and the right loudspeaker unit 22 connected with the first embodiment of the sound image localization device 10.

Further, while there has been described in the present embodiment about the fact that the sound image is localized based on sounds outputted from two sound sources, viz., the left loudspeaker unit 51 and the right loudspeaker unit 52, this does not limit the present invention. The same effect can still be obtained when the directivity control processes are carried out even though, for example, the left loudspeaker unit may be constituted by two loudspeaker units, the right loudspeaker unit may be constituted by one loudspeaker unit, or one or more loudspeaker units may be additionally arranged between the left loudspeaker unit 51 and the right loudspeaker unit 52.

Further, while there has been described in the present embodiment about the fact that the first filter 12, the second filter 13, and the directivity control means 60 are separately provided, this does not limit the present invention. According to the present invention, the sound image localization device may comprise a third directivity filter having the first filter 12, the first compensation filter 61, and the first directivity control filter 63 integrally included therein, and a fourth directivity filter having the second filter 13, the second compensation filter 62, and the second directivity control filter 64 integrally included therein. In this case, the third directivity filter and the fourth directivity filter are respectively set at filter coefficients HsR and HsL, represented by the expressions (7) and (8) described as below.
HsR=HR×CR+HL×CL×DL (Expression 7)
HsL=HL×CL+HR×CR×DR (Expression 8)

Further, while there has been described in the present embodiment about the fact that the sound image is localized based on sounds outputted from two sound sources, viz., the left loudspeaker unit 51 and the right loudspeaker unit 52, this does not limit the present invention. The same effect can still be obtained when more than two loudspeaker units are provided.

In this case, the same effect as the case that two loudspeaker units are provided as described in the above can still be obtained when the directivity control means 60 is operative to control directivities of more than two loudspeaker units in such a manner that high band acoustic signals have directivities toward one of the left and right ears of the listener to the degree that high band sounds reached at the left ear of the listener and the high band sounds reached at the right ear of the listener are different from each other in a sound pressure level by equal to or greater than 10 dB, and inverse filter process is carried out on the sound field for the low band acoustic signals.

### INDUSTRIAL APPLICABILITY OF THE PRESENT INVENTION

As will be seen from the foregoing description, it will be understood that the present embodiment of the sound image localization device has an effect of localizing a sound image in an arbitrary direction around a listener while mitigating the restriction of the listening position in comparison with the conventional apparatus, and available as, for example, a sound image localization device for localizing a sound image constituted by sounds outputted from a cellular phone, a portable game machine, and the like.

What is claimed is:

1. A sound image localization device, comprising:
high-band localization means for localizing a high band sound image constituted by high band sounds equal to or higher in frequency than a predetermined value and outputted from left and right acoustic outputting units arranged so as to generate a sound field having directivity in high band sounds; and
low-band localization means for localizing a low band sound image constituted by low band sounds lower in frequency than a predetermined value and outputted from said left and right acoustic outputting unit, and in which
said low-band localization means is operative to localize said low band sound image, in accordance with transfer functions respectively indicative of paths from a target position, at which said low band sound image is to be localized, to left and right ears of a listener and transfer functions respectively indicative of paths from said left and right acoustic outputting units to the left and right ears of the listener.

2. A sound image localization device as set forth in claim 1, in which
said high-band localization means is operative to localize said high band sound image, in accordance with a transfer function indicative of a path from a target position, at which said high band sound image is to be localized, to left and right ears of the listener, a transfer function indicative of a path from said right acoustic outputting unit to the left ear or said right ear of the listener, whichever is closer to said right acoustic outputting unit, and a transfer function indicative of a path from said left acoustic outputting unit to the left ear or the right ear of the listener, whichever is closer to said left acoustic outputting unit.

3. A sound image localization device as set forth in claim 1, in which
said low-band localization means includes first filter means for adding an effect caused by said transfer function indicative of a path from a target position, at which said low band sound image is to be localized, to left and right ears of a listener and second filter means for eliminating an effect caused by said transfer function indicative of said path from said left and right acoustic outputting units to the left and right ears of the listener.

4. A sound image localization device as set forth in claim 1, which further comprises directivity control means for controlling directivity in high band sounds higher in frequency than a predetermined value outputted from said left and right acoustic outputting units.

5. A sound image localization device as set forth in claim 4, in which
said directivity control means includes third filter means for eliminating an effect caused by a transfer function indicative of a path from said right acoustic outputting unit to the left ear or the right ear of the listener, whichever is remoter to said right acoustic outputting unit, and a transfer function indicative of a path from said left acoustic outputting unit to the left ear or the right ear of the listener, whichever is remoter to said left acoustic outputting unit.

6. A sound image localization device as set forth in claim 1, in which
said left and right acoustic outputting units are facing outwardly from each other.

7. A sound image localization device as set forth in claim 1, in which
said left and right acoustic outputting units are respectively facing to and spaced apart from the left and right ears of the listener at a predetermined distance.

8. A sound image localization device as set forth in claim 1, in which
said left and right acoustic outputting units are set in such a manner that high band sounds outputted from said left and right acoustic outputting units and reached at the left ear of the listener and high band sounds outputted from said left and right acoustic outputting units and reached at the right ear of the listener are different from each other in a sound pressure level by equal to or greater than 10 dB.

9. A sound image localization device as set forth in claim 1, in which
said high-band localization means and said low-band localization means are integral with each other.

10. A sound image localization device as set forth in claim 1, in which
at least one of said left and right acoustic outputting units is constituted by a plurality of loudspeaker units.

11. A sound image localization device as set forth in claim 1, in which
at least one of said left and right acoustic outputting units has a predetermined directivity.
